(19) United States
(12) Patent Application Publication
(10) Pub. No.: US 2007/0077876 A1
(43) Pub. Date: Apr. 5, 2007

(54) Ceramic tipped tool

(76) Inventors: Lamont A. Rogers, Chatsworth, GA (US); Thomas J. Walz, Tacoma, WA (US)

Correspondence Address: GARDNER GROFF SANTOS & GREENWALD, P.C., 2018 POWERS FERRY ROAD, SUITE 800, ATLANTA, GA, 30339, US

(21) Appl. No.: 11/390,860

(22) Filed: Mar. 28, 2006

Related U.S. Application Data
(60) Provisional application No. 60/596,568, filed on Oct. 4, 2005.

(51) Int. Cl. B24D 11/00; B23F 21/03

(52) U.S. Cl. 451/541; 51/297

(57) ABSTRACT

A ceramic-tipped tool with a sharp-edged ceramic cutting element attached to a tool body made of another material. The ceramic cutting element is desirably a cermet and is desirably brazed to another material such as steel to form a tool that may be used to cut various materials and maintain a sharp edge after repeated uses.

### CROSS-REFERENCE TO RELATED APPLICATION

This application claims the benefit of U.S. Provisional Patent Application Ser. No. 60/596,568, filed Oct. 4, 2005, which application is incorporated herein by reference in its entirety for all purposes.

### TECHNICAL FIELD

The present invention relates generally to a cutting tool apparatus providing improved performance and/or useful life and including a cutting edge portion formed of a first material, such as a ceramic, to a shank or base formed of a second material, such as steel. The present invention also relates to means, methods and/or modes of manufacturing and using such a tool.

### BACKGROUND OF THE INVENTION

Ceramics have attributes such as high wear and corrosion resistance as well as an ability to take and maintain an extremely sharp edge and hold that edge through numerous wear cycles.

Steels, other metals and other materials currently used as knives have advantages such as flexibility, low cost and desirable material properties such as flexural strength, toughness, and a modulus of elasticity not ordinarily found in ceramics.

In saw blades, drill bits, and other tools combining metal and ceramic portions, the bonding area is typically relatively large in comparison to the typical bonding area available on a knife or other edged cutting tools. This larger bonding area allows for joining the metal and ceramic using lap and other large surface contact area joints. In a knife edge, however, the smaller bonding area available generally dictates joinder at a butt joint, which is typically a weaker type of joint.

In many applications that use cutting tools, the tool must slide through something such as a guide or the material being cut. Using a lap joint, scarf joint, through joint or inset joint requires a certain thickness of material which increases the force required for cutting, and may render it impossible to use the tool in existing guides. Also, certain applications, such as tuft cutting in carpet manufacturing, require a series of knives in close proximity, such that the thinnest possible knife is the most desirable. Thus, larger surface contact area joints may be incompatible with such cutting tools. However, because it would be desirable in such applications to provide the body or shank of such a tool formed of a material such as steel, other metal or metal alloys, and a cutting edge or tip of a higher wear material such as ceramic, cemented ceramic or other material, needs exist for improved bonding methods to provide stronger attachment at a butt joint.

A tufting machine is generally like a fifteen-foot wide sewing machine with anywhere from 700 to 2400 parts. Some carpet mills have to re-sharpen the steel cutting knives associated with a tufting machine as often as once every 24 hours. This can become a very expensive procedure and sometimes forces the mills to shut down while the re-sharpening process is ongoing. A large amount of revenue may be lost while the mills are shut down. In general, it has not been possible to achieve the benefits which could be achieved by using cutting tools made from a ceramic or other hard material in tufting machines, mainly because of the difficulty of reliably bonding the ceramic cutting tip to the thin base or shank of the tool. Thus, when ceramics (including cermets) have been used in tools, it is commonly in indexable or mechanically held applications or in lap jointed connections, inset in tools. For example, ceramic cutting elements have been known to be used in rotary cutting tool applications where the cutter inserts are placed in a pocket at the perimeter of the tool and mechanically held in place. However, it has not been found to be commercially practicable to employ ceramics where they must be brazed or otherwise bonded to the base or shank of a thin tool or knife at a butt joint. Therefore, it can be seen that a need exists for improved tools and methods of creating such tools; and more specifically, for cutting tools formed from a combination of metal and ceramics.

### SUMMARY OF THE INVENTION

The present invention provides a commercially feasible process for joining ceramic parts to a substrate in a commercially viable manner, so that the process has a desirable balance of advantageous features, such as, high bond strength at high temperatures, resistance to hostile environments (e.g. contact with corrosive materials, subject to high impact, subject to residual stresses and vibration, etc.) high wear resistance, low cost, being able to accomplish the process rapidly and simply, and being an environmentally desirable process.

In one aspect, the present invention is a cutting tool including a metal tool body having a first planar bonding surface and a ceramic cutting element having a second planar bonding surface. The first planar bonding surface is joined to the second planar bonding surface by providing the second planar bonding surface as a clean surface which is substantially free from contaminants, activating at least one of the first and second planar bonding surfaces by chemical treatment, fluxing the interface between the first and second planar bonding surfaces, and bonding the first planar bonding surface and the second planar bonding surface together.

In another aspect, the present invention is a tuft-cutting tool for carpet, the tool including a metal shank portion for replaceable engagement in a tufting machine, and a ceramic-based cutting element affixed to an end of the metal shank portion having a planar bonding surface joined to the end of the metal shank portion. The planar bonding surface is joined to the end of the metal shank portion by providing the planar bonding surface of the ceramic-based cutting element as a clean surface which is substantially free from contaminants, activating at least one of the end of the metal shank portion and the planar bonding surface of the ceramic-based cutting element by chemical treatment, fluxing the interface between the metal shank portion and the planar bonding surface of the ceramic-based cutting element, and bonding the metal shank portion and the planar bonding surface of the ceramic-based cutting element together.

In still another aspect, the present invention is a method of bonding a first planar surface of a metal tool body to a second planar surface of a ceramic cutting member. The method preferably includes activating at least one of the first and second planar surfaces by chemical treatment, fluxing the interface between the first and second planar surfaces, fixturing a braze alloy between the first and second planar surfaces, and heating the at least one metallic member, the at least one ceramic member, and the braze alloy to between 45 degrees Fahrenheit and 55 degrees Fahrenheit above the melting point of the braze alloy such that the at least one metallic member and the at least one ceramic member are joined together upon cooling to a temperature below the melting point of the braze alloy.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 is a perspective view of a ceramic tipped tool according to an example embodiment of the present invention.

FIG. 2 is a magnified view of the ceramic tipped tool shown in FIG. 1.

FIG. 3 is an exploded view of the ceramic tipped tool shown in FIG. 1, depicted without any braze alloy.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

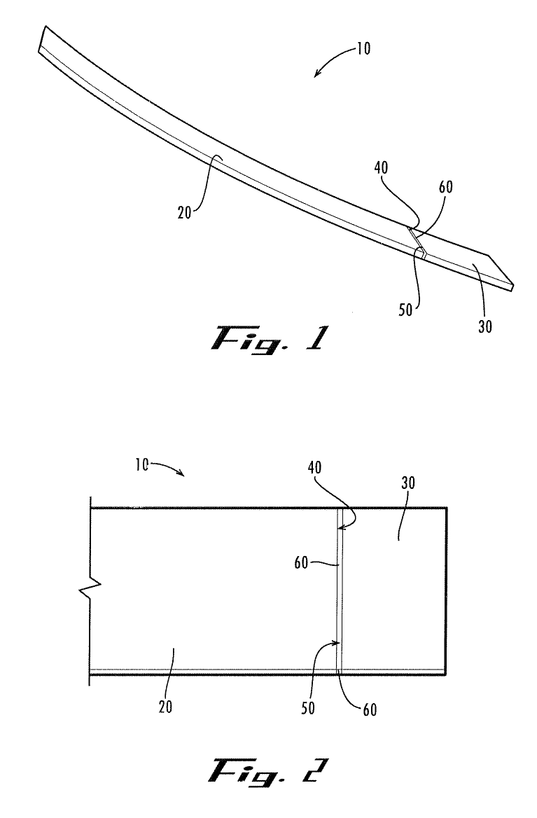

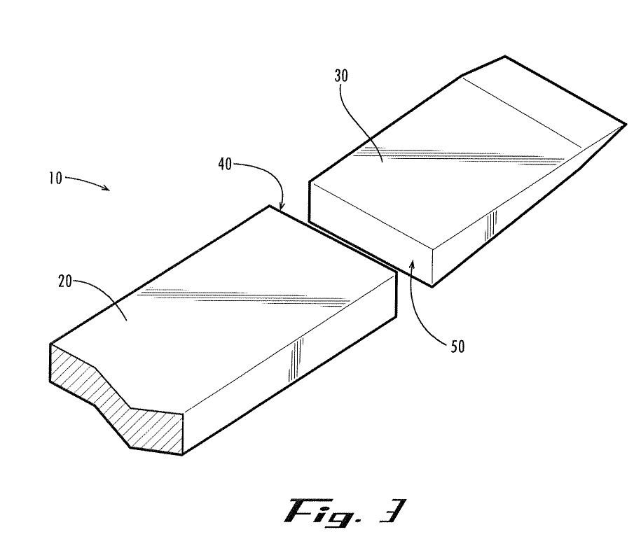

With reference now to the drawing figures, FIGS. 1-3 show a ceramic tipped tool 10 according to an example form of the invention, the tool having a metal tool body, shank or base 20, and a ceramic cutting element 30. The metal tool body 20 has a first planar bonding surface 40, and the ceramic cutting element 30 has a corresponding second planar bonding surface 50 with dimensions generally matching those of the first planar bonding surface.

Preferably, the ceramic cutting element 30 is made of a ceramic material such as a cermet, and is formed in the desired shape by conventional manufacturing techniques depending on the application required the cutting element 30 preferably has at least one sharp cutting edge. In a first example embodiment of the present invention, the ceramic material of which the cutting element 30 is formed is a metal-based ceramic, such as those based on tungsten, titanium, aluminum, silicon and/or other metals, joined with carbon, nitrogen and other similar materials, or combinations thereof, such as for example Titanium Carbonitride (as TiCN, TiC/TiN, TiC(N), TiC/N and others), Tungsten Carbide (as WC, WC/Co, WC(Co), WC/Ni, WC(Ni), WC(NiCr) and others), Titanium Carbide (as TiC and others), Titanium Nitride (as TiN and others), Aluminum Oxide (as Al₂O₃ and others), Silicon Nitride (as Si₃N₄ and others), Silicon Carbide (as SiC and others), as well as combinations of these examples and other chemical compounds.

In example embodiments, the ceramic tipped tool 10 of the present invention is prepared and manufactured in the following manner:

1. The tool body 20 and the cutting element 30 are thoroughly cleaned.

2. These parts are then treated in such a manner as to prepare the surface to bond with an intermediate material.

3. The corresponding planar bonding surfaces to be joined, 40 and 50, are then fluxed.

4. These surfaces, 40 and 50, are then placed the desired distance apart for a good butt joint.

5. A piece of braze alloy 60 coated in flux is placed in, on, or adjacent to the areas to be joined.

6. The parts are heated to the proper temperature at which joining occurs.

7. The parts are cooled.

8. The parts are cleaned as necessary.

In a particular example embodiment of the present invention, a ceramic part such as a cermet consisting of tungsten carbide is used to form the cutting element 30 of a blade for a carpet tufting machine, or other thin, edged cutting tool. The cutting element 30 is affixed at a butt joint to a thin metal tool shank 20. An example process by which the ceramic tipped tool 10 is produced is hereafter summarized.

Step 1. Selecting Materials.

In this embodiment, a piece of stock steel about 3.50 inches long, by about 0.500 inches wide, by about 0.025 inches thick is chosen for the tool body 20. Of course in other embodiments these dimensions may vary depending on the intended application. The steel is preferably 1095 steel, hardened and tempered to a condition of hardness of between 48-51 and, more preferably about 50, on the Rockwell C hardness scale.

The thickness of cutting element 30 is preferably between 0.005 inches to 0.05 inches, and the width is preferably between 0.1 inches to 1.0 inch. In a particular form of the invention suitable for tufting machine blades, the carbide tip is about 0.025 inches thick, by about 0.500 inches wide, with one side's length being about 0.300 inches and the other side's length being about 0.500 inches.

A piece of braze alloy 60 formed as a wire of about 0.008 inches in diameter is cut to length to match the distance to be brazed, which is typically about 0.050 inches in length. In other applications within the scope of the invention, the diameter and length of the wire to be brazed will vary according to the tool geometry. The braze alloy 60 is preferably a high impact braze alloy from Carbide Processors, Inc., but in other embodiments a variety of alloys can be used.

Step 2. Cleaning

The surfaces of the components are preferably cleaned to remove all stains, oil, dust, etc., and to create additional roughness on the surface. A preferred method of cleaning the cutting element 30 is through a cathodic electro-cleaning process in alkaline solution, as discussed in U.S. Pat. No. 5,624,626. The part may be further processed as described in U.S. Pat. Nos. 6,322,871 and 2,979,811 or any other mode that adequately prepares the material for brazing. The content of U.S. Pat. Nos. 5,624,626, 6,322,871 and 2,979,811 are incorporated by reference herein. The tool body 20 is also cleaned, for example in similar fashion to that described above. Additionally, in a preferred embodiment of the present invention the tool body 20 has one end ground to form a rough, square, clean surface for brazing. In a preferred embodiment of the present invention the braze alloy 60 is also cleaned.

Step 3. Fluxing

The ends of the carbide and steel to be mated, as well as the braze alloy, are preferably all fluxed. In a preferred form of the invention the flux is Purified Black form Carbide Processors, Inc., although it will be understood that various alternate forms of flux may be used depending on the application and the particular component materials utilized.

Step 4. Fixturing

The cutting element 30, braze alloy 60 and tool body 20 are preferably fixtured in place before heating. In a preferred form of the invention the fixturing is ceramic. The components are preferably securely fixtured with their planar surfaces confronting one another, and slightly spaced or directly abutting one another, configured according to the desired final lap joint configuration.

Step 5. Heating

In example forms, the braze alloy 60, tool body 20, and cutting element 30, are preferably brought to a temperature of between 45 degrees Fahrenheit to 55 degrees Fahrenheit, and more preferably about 50 degrees Fahrenheit, above the melting point of the braze alloy 60. In alternative forms, the braze alloy 60, tool body 20, and cutting element 30, are heated to within a temperature range recommended by the American Welding Society, or other similar guidelines, for the brazing range of the alloy. In a preferred form of the invention, the heating source may be induction heating, although other forms of heating may be used in alternate embodiments.

Step 6. Cooling

The parts are preferably air cooled. In alternate forms, other cooling methods such as refrigeration, fluid-quenching, sand quenching, or controlled heat removal can be used.

In other example methods of fabrication according to the present invention, a welding process, a braze welding process or a gluing process are used to form a lap or butt joint joining the cutting element 30 to the tool body 20.

The aforementioned joinder method results in a knife or similar cutting tool with the potential for a sharper cutting edge, longer cutting life, reduced operating cost and increased flexibility and/or strength over a knife or similar tool comprised of a single material.

With regard to the ceramic materials which are to be bonded to a substrate, within the very broad scope of the present invention a wide variety of such ceramic materials would be suitable. In general, metal based ceramics are believed to be well-adapted for use in the present invention. Titanium, aluminum, tungsten, and/or silicon and combinations thereof in combination with carbon, nitrogen, oxygen and combinations of these would be found suitable. Further, ceramics based on titanium, aluminum and combinations thereof have been found to work particularly well in the present invention. Specific examples of these are tungsten carbide, titanium carbonitride, titanium carbide, and also aluminum oxide enriched with titanium carbide. The invention also comprehends the use of combinations of these and also the incorporation of other ingredients thereto.

With regard to the joining material to be used for the bonding, within the very broad scope of the present invention a wide variety of such materials would be suitable. In general, the braze alloys which are included in AWS (American Welding Society) Bag (silver-based braze alloys) classification are believed to be in general well-adapted for use in the present invention, especially those recommended for tungsten carbide, although other alloys can perform well. Other alloys such as solder, active braze alloys, glues, epoxies, and braze filler metals can also perform well.

With regard to the tool body 20, within the very broad scope of the present invention a wide variety of materials would be found suitable. In general, steels and other materials, metal alloys, ceramics and certain plastics can perform well.

A first step in example forms of the present invention is properly cleaning the surfaces of the parts involved. It is conceivable that the parts would be provided with the bonding surface thereof freshly cleaned and ready for use, in which case the first step of the present invention would be simply providing such cleaned ceramic pieces. However, this may not be the case, in which case further cleaning steps may be advantageous. As indicated previously, the preferred method of cleaning is through the use of an alkaline solution as described in U.S. Pat. No. 5,624,626. Within the broader scope of the present invention, other cleaning methods, and/or optionally cleaning in combination with accomplishing other benefits such as activating the surface, optionally pitting the surface somewhat, or otherwise chemically treating the surface can be implemented. Further, such steps as degreasing with trichlorides, caustic or alkaline solutions, or acetone can be used, followed by solvents such as in combination with rinses (e.g., with an alcohol rinse). Common contaminants would include dirt, oil and greases, which should be removed, and also oxides that should be removed as much as possible. Various physical methods such as grinding, blasting and similar methods can also be effectively implemented.

Other methods of fluxing may also give suitable results. Fluxing with other materials, fluxing with atmosphere, brazing in a special atmosphere, brazing in a vacuum, shielded welding and similar techniques may also provide suitable results.

The fixturing utilized may be ceramic or other suitable materials, or the parts may be attached while unfixtured, and may or may not be manipulated or otherwise moved or arranged during the operation.

### EXAMPLE 1

Step 1. Cleaning

A knife tip composed of WC or WC/Co (tungsten carbide ceramic particles cemented in a cobalt matrix) is provided. Upon visual inspection, the surfaces of the tip are relatively free of pitting and include some contaminants, such as carbonized oils, free carbon, iron oxide, general dust, shop contaminants and metal particles. The knife tip is prepared by one of the methods described.

Upon microscopic inspection (1000 times), the surface is clean but smooth and relatively unpitted. In addition, the surfaces of the tips are substantially free of contaminants.

A piece of 1095 steel strip that is 0.025″ thick by 0.500 inches wide is obtained and cut to the desired shank or shaft length. The end is then dressed in bench grinder until it is clean and square.

A clean piece of braze alloy is obtained.

Step 2. Fluxing

Purified Black flux is applied to all three components by dipping.

Step 3. Fixturing

The parts are arranged in the desired manner to form a butt joint, and held in place by ceramic fixturing.

Step 4. Heating

The parts are heated, exposing the fixtured arrangement under the influence of a coil in an induction heating unit.

Step 5. Cooling

The joined parts are air cooled in the fixture, and upon reaching ambient room temperature (or cool enough to set and allow for safe handling) are removed from the fixture.

The tool is then inspected, optionally further cleaned, tested and/or packaged, and may then be placed into operation in its intended application.

### EXAMPLE 2

Example 1 is repeated, except the tip material is Titanium Carbide.

### EXAMPLE 3

Example 1 is repeated, except the tip material is Titanium Nitride.

### EXAMPLE 4

Example 1 is repeated, except the tip material is Titanium CarbonNitride.

### EXAMPLE 5

Example 1 is repeated, except the tip material is Alumina with a Titanium Carbide addition.

### EXAMPLE 6

Examples 1, 2, 3 and 4 are repeated, except the steel is mild steel.

### EXAMPLE 7

Examples 1, 2, 3 and 4 are repeated, except the steel is a stainless steel.

### EXAMPLE 8

Examples 1, 2, 3 and 4 are repeated, except the shaft is Titanium.

### EXAMPLE 9

Examples 1, 2, 3 and 4 are repeated, except the braze alloy is AWS Bag-22

### EXAMPLE 10

Examples 1, 2, 3 and 4 are repeated, except the braze alloy is AWS Bag-24

### EXAMPLE 11

Examples 1, 2, 3 and 4 are repeated, except the braze alloy is AWS Bag-3

### EXAMPLE 12

Examples 1, 2, 3 and 4 are repeated, except the braze alloy is another braze alloy.

### EXAMPLE 13

Examples 1, 2, 3 and 4 are repeated, except a solder is used in place of the braze alloy.

### EXAMPLE 14

Examples 1, 2, 3 and 4 are repeated, except the joining material is a paste.

### EXAMPLE 15

Examples 1, 2, 3 and 4 are repeated, except the joining material is a ribbon.

### EXAMPLE 16

Examples 1, 2, 3 and 4 are repeated, except the joining material is a liquid.

### EXAMPLE 17

Examples 1, 2, 3 and 4 are repeated, except the joining material is a bar.

### EXAMPLE 18

Examples 1, 2, 3 and 4 are repeated, except the parts are epoxied.

### EXAMPLE 19

Examples 1, 2, 3 and 4 are repeated, except the parts are braze welded.

### EXAMPLE 20

Examples 1, 2, 3 and 4 are repeated, except the parts are welded.

### EXAMPLE 21

Examples 1, 2, 3 and 4 are repeated, except the joint is a lap joint.

### EXAMPLE 22

Examples 1, 2, 3 and 4 are repeated, except the joint is an Inset joint.

### EXAMPLE 23

Examples 1, 2, 3 and 4 are repeated, except the joint is a through joint.

### EXAMPLE 24

Examples 1, 2, 3 and 4 are repeated, except the flux is a white flux.

### EXAMPLE 25

Examples 1, 2, 3 and 4 are repeated, except the flux is a black flux.

### EXAMPLE 26

Examples 1, 2, 3 and 4 are repeated, except the fluxing action is accomplished by carrying out the joinder of components within a controlled atmosphere.

### EXAMPLE 27

Examples 1, 2, 3 and 4 are repeated, except the fluxing action is accomplished by carrying out the joinder of components within a vacuum.

### EXAMPLE 28

Examples 1, 2, 3 and 4 are repeated, except the heat source is a torch.

### EXAMPLE 29

Examples 1, 2, 3 and 4 are repeated, except the heat source is an oven.

### EXAMPLE 30

Examples 1, 2, 3 and 4 are repeated, except the heat source is a furnace.

### EXAMPLE 31

Examples 1, 2, 3 and 4 are repeated, except the heat source is a laser.

### EXAMPLE 32

Examples 1, 2, 3 and 4 are repeated, except the heat source is friction.

While the invention has been described with reference to preferred and example embodiments, it will be understood by those skilled in the art that a variety of modifications, additions and deletions are within the scope of the invention, as defined by the following claims.

What is claimed is:

1. A cutting tool comprising:
a metal tool body having a first planar bonding surface;
a ceramic cutting element having a second planar bonding surface, the first planar bonding surface being joined to the second planar bonding surface by the process of:
providing the second planar bonding surface as a clean surface which is substantially free from contaminants;
activating at least one of the first and second planar bonding surfaces by chemical treatment;
fluxing the interface between the first and second planar bonding surfaces; and
bonding the first planar bonding surface and second planar bonding surface together.

2. The cutting tool of claim 1, wherein a brazing process is used to bond the first planar bonding surface and the second planar bonding surface together.

3. The cutting tool of claim 1, wherein a welding process is used to bond the first planar bonding surface and the second planar bonding surface together.

4. The cutting tool of claim 1, wherein glue is used to bond the first planar bonding surface and the second planar bonding surface together.

5. The cutting tool of claim 1, wherein epoxy is used to bond the first planar bonding surface and the second planar bonding surface together.

6. The cutting tool of claim 1, wherein solder is used to bond the first planar bonding surface and the second planar bonding surface together.

7. The cutting tool of claim 1, wherein the ceramic cutting edge comprises a metal-based ceramic.

8. The cutting tool of claim 7, wherein the ceramic cutting edge is comprises a cermet.

9. The cutting tool of claim 1, wherein the ceramic cutting edge comprises at least one material selected from the group of carbon, nitrogen, boron and/or oxygen.

10. The cutting tool of claim 9, wherein the ceramic cutting edge comprises at least one material selected from the group of titanium, aluminum, tungsten, and/or silicon.

11. The cutting tool of claim 1, wherein the ceramic cutting edge comprises at least one composition selected from the group of titanium carbide, tungsten carbide, titanium carbonitride, titanium nitride, and/or aluminum oxide.

12. The cutting tool of claim 11, wherein the elongated body comprises at least one material selected from the group of steel, titanium, aluminum, tungsten, silicon, carbon, nitrogen, and/or oxygen.

13. The cutting tool of claim 1, wherein a coating application is applied to the exterior surface of the ceramic cutting edge.

14. The cutting tool of claim 13, wherein the coating application is applied to the exterior surface of the elongated body.

15. The cutting tool of claim 14, wherein the coating application is carbon based.

16. A tuft-cutting tool for carpet, comprising a thin metal shank portion for replaceable engagement in a tufting machine, said shank portion having a width of between 0.1 inches to 1.0 inch, and a thickness of between 0.005 inches to 0.05 inches;
said tool further comprising a ceramic-based cutting element affixed to an end of the metal shank portion, said cutting element having a sharp edge, and a planar bonding surface joined to said end of the metal shank portion by the process of:
providing the planar bonding surface of the ceramic-based cutting element as a clean surface which is substantially free from contaminants;
activating at least one of the end of the metal shank portion and the planar bonding surface of the ceramic-based cutting element by chemical treatment;
fluxing the interface between the metal shank portion and the planar bonding surface of the ceramic-based cutting element; and
bonding the metal shank portion and the planar bonding surface of the ceramic-based cutting element together.

17. A method of bonding a first planar surface of a metal tool body to a second planar surface of a ceramic cutting element, said method comprising:
activating at least one of the first and second planar surfaces by chemical treatment;
fluxing the interface between the first and second planar surfaces;
fixturing a braze alloy between the first and second planar surfaces;
heating the metal tool body, the ceramic cutting element, and the braze alloy to between 45 degrees Fahrenheit and 55 degrees Fahrenheit above the melting point of the braze alloy such that both the metal tool body and the ceramic cutting element are joined together upon cooling to a temperature below the melting point of the braze alloy.

18. The method of claim 17, wherein the ceramic cutting element comprises at least one material selected from the group of steel, titanium, aluminum, tungsten, silicon, carbon, nitrogen, and/or oxygen.

19. The method of claim 17, wherein the ceramic cutting element comprises at least one composition selected from the group of titanium carbide, tungsten carbide, titanium carbonitride, titanium nitride, and/or aluminum oxide.

20. The method of claim 17, wherein the metal tool body has a Rockwell C hardness of between 48-51.

21. The method of claim 20, wherein the metal tool body is 1095 hardened steel.

22. The method of claim 17, wherein the braze alloy is a high-impact braze alloy.

23. The method of claim 17, wherein the metal tool body, the ceramic cutting element, and the braze alloy are cleaned by a cathodic electro-cleaning process before being fluxed.

24. The method of claim 17, wherein the metal tool body, the ceramic cutting element, and the braze alloy areheated to about 50 degrees Fahrenheit above the melting point of the braze alloy.

25. The method of claim 17, wherein the ceramic cutting element comprises a cutting edge.
